(19) United States
(12) Patent Application Publication
(10) Pub. No.: US 2003/0142339 A1
(43) Pub. Date: Jul. 31, 2003

(54) Discounted printing

(75) Inventor: Maurizio Pilu, Bristol (GB)

Correspondence Address: HEWLETT-PACKARD COMPANY, Intellectual Property Adiministration, P.O. Box 272400, Fort Collins, CO, 80527-2400, US

(73) Assignee: HEWLETT PACKARD COMPANY

(21) Appl. No.: 10/346,357

(22) Filed: Jan. 17, 2003

(30) Foreign Application Priority Data
Jan. 31, 2002 (GB) 0202180.6

(51) Int. Cl. G06F 15/00; B41F 1/00

(52) U.S. Cl. 358/1.14

(57) ABSTRACT

A method for authorising discounted printing, comprising identifying content which has been captured by a consumer in authorised defined circumstances, and authorising discounted consumer printing of the identified content or of further content linked to the identified content

### FIELD 0F THE INVENTION

The present invention relates generally to discounted printing. More particularly, but not exclusively, the invention relates to a method and system for authorising discounted printing.

### DESCRIPTION OF PRIOR ART

International Patent Application Publication Number WO-A1-01/02948 discloses allowing a printer's or a user's account to accumulate a credit balance and for all or a portion of this balance to be presented to the corresponding user or users as a collection of points. If the printer account has a credit balance, then the corresponding points may be redeemed by the user or users for particular products or services.

International Patent Application Publication Number WO-A1-01/02946 discloses a printer module having an account that contains data indicative of the usage of the printer. The account is debited with amortized capital costs and running costs of the printer and credited with fees earned via the printer. Any credit balance can be redeemed.

International Patent Application Publication Number WO-A1-00/76204, assigned to Hewlett-Packard Company, discloses a document delivery system for automatically printing a document on a printing device. When a print schedule indicates that a document should be printed, the document is automatically transmitted to the printing device. A user profile is stored that contains information about a recipient of the document. The user profile can be used to select advertising to be included in the document. A product can be subsidized for a user, based on the information contained in the user profile. For, example, if a user profile indicates that a user has printed a number of preferred documents, a product such as an ink consumable can be sent to the user.

None of the prior art documents noted above facilitates associating authorised circumstances in which a capture device is used to capture content with a discount for consumer printing of the captured content or content linked thereto.

### SUMMARY OF THE INVENTION

In accordance with the invention, there is provided a method for authorising discounted printing, comprising identifying content which has been captured by a consumer in authorised defined circumstances, and authorising discounted consumer printing of the identified content or of further content linked to the identified content.

In accordance with a further aspect of the invention, there is provided computer apparatus having stored thereon data relating to authorised defined capture circumstances, for use in a method as described above, the computer apparatus being operable to automatically compare identifying data relating to captured content with stored data relating to authorised defined capture circumstances and to authorise or deny discounted consumer printing according to results of the comparison.

In accordance with a still further aspect of the invention, there is provided a system operable to identify content which has been captured by a consumer in authorised defined circumstances, and to authorise discounted consumer printing of the identified captured content or of further content linked to the identified captured content.

In accordance with a still further aspect of the invention, there is provided a method for use in authorising discounted consumer printing, comprising providing, for receipt by a consumer and/or a capture device of the consumer, identifying data for association with content captured in defined circumstances so as to enable secure identification of the circumstances in which the content was captured.

In accordance with a still further aspect of the invention, there is provided a capture device, for use with a method as described above, operable to receive identifying data in defined circumstances and to associate the identifying data with content captured in the defined circumstances so as to enable secure identification of the captured content and of the circumstances in which it was captured.

In accordance with a still further aspect of the invention, there is provided a method of providing discounted printing consumables to a consumer thereof, the discount representing a proportion of the costs incurred by the consumer for consumer printing of captured content, or of further content linked to said captured content, wherein a condition of the discounting is that said captured content is captured in defined circumstances.

In accordance with a still further aspect of the invention, there is provided a method of associating content, which has been captured in defined circumstances, with a discount service so as to enable discounted consumer printing of the captured content or of further content linked to the captured content.

In accordance with a still further aspect of the invention, there is provided a method wherein a discounted consumer printing service provider provides a discount printing service for consumers of content captured in authorised defined circumstances, or of content linked to the captured content, the service including the provision of information enabling a printing consumables provider to provide to respective said consumers printing consumables at a discount related to an estimated cost of printing said content by the respective consumers, for thereby encouraging the consumers to print said content.

In accordance with a still further aspect of the invention, there is provided a method wherein a printing consumables provider provides for a stakeholder in content captured by a consumer in authorised defined circumstances, or of content linked to the captured content, a discount printing service in which the printing consumables provider provides printing consumables to the consumer at a discount related to estimated costs of printing by the consumer of said content, whereby the consumer is encouraged to print said content.

In accordance with a still further aspect of the invention, there is provided a method of identifying content which has been captured by a consumer in authorised defined circumstances, for authorising discounted consumer printing of the identified content or of further content linked to the identified content, wherein identifying data relating to the circumstances of capture, which has been captured and stored with the captured content, is used for securely identifying whether the captured content has been captured in said authorised defined circumstances.

In accordance with a still further aspect of the invention, there is provided a method of identifying content which has been captured by a consumer in authorised defined circumstances, for authorising discounted consumer printing of the identified content or of further content linked to the identified content, comprising;

a) using identifying data relating to the circumstances of capture for securely identifying whether the captured content has been captured in said authorised defined circumstances;

b) estimating costs incurred by a consumer for printing the identified or linked content;

c) providing printing consumables to the consumer at a discount substantially proportional to estimated printing costs; and

d) billing a stakeholder in the identified or linked content for provision of discounted consumer printing services including authorisation of discounted printing and/or providing consumables to the consumer at a discount.

In accordance with a still further aspect of the invention, there is provided means for authorising discounted printing, comprising means for identifying content which has been captured by a consumer in authorised defined circumstances, and means for authorising discounted consumer printing of the identified content or of further content linked to the identified content.

### DESCRIPTION OF THE DRAWINGS

In order that the invention may be well understood, various embodiments thereof will now be described, by way of example only, with reference to the accompanying drawings, in which:

FIG. 1 shows schematically four parties involved in a method of discounted consumer printing;

FIG. 2 is a flow diagram illustrating a method according to a first embodiment;

FIG. 3 is a flow diagram illustrating a modification of the method of FIG. 2;

FIG. 4 is a flow diagram illustrating another modification of the method of FIG. 2; and

FIG. 5 is a schematic diagram illustrating a variation of the method described with reference to FIG. 4.

### DETAILED DESCRIPTION OF THE EMBODIMENTS

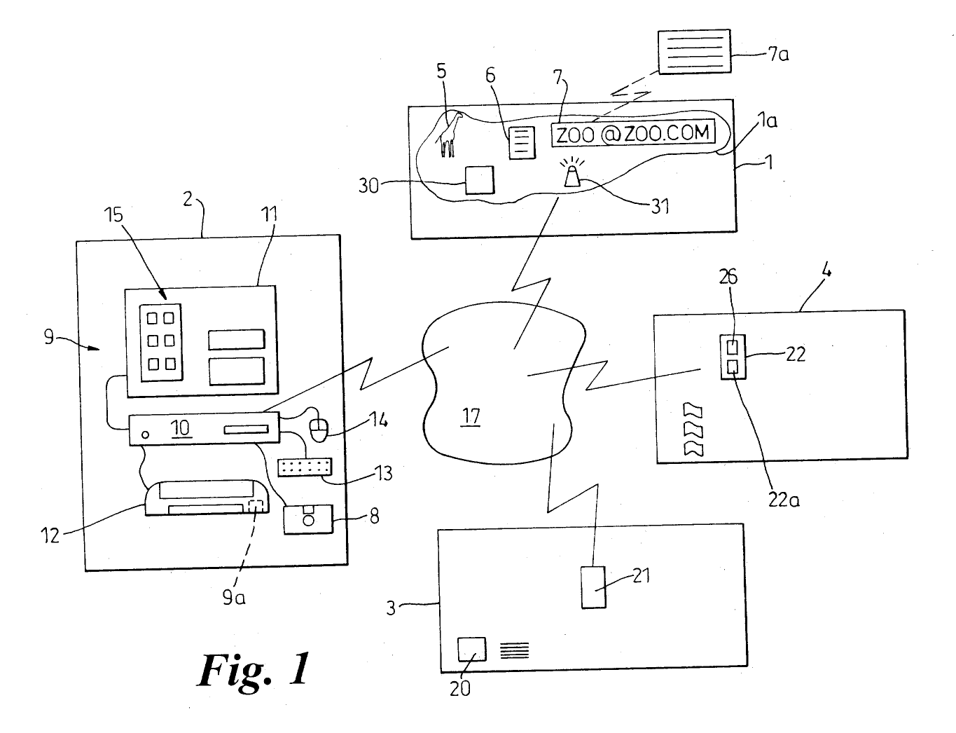

FIG. 1 shows schematically four parties: a provider 1 of content, a consumer 2, a provider 3 of printing consumables, and a discounted consumer printing service provider 4. The content is capturable by the consumer 2 using a capture device 8, for example an image capture device such as a digital camera and/or a personal digital assistant with wireless communication capability, or a combination of both in a single device.

The term content includes any type of imagery or information which it would be desirous for the consumer 2 to capture for possible later printing. For example, the content may comprise visual images of scenes 5 at a location managed by the content provider 1, preprepared digital information 6 in the form of digital images and/or text and/or sound files associated with a location or event managed by the content provider 1, or a pointer 7 to content, the pointer 7 taking the form, for example, of a uniform resource locator (URL) enabling a consumer to obtain preprepared digital information stored on web pages linked to the URL. Advantageously, the content is in some way relevant to activities carried out by or subject matter associated with the content provider 1.

The consumer 2 has an interest in using the capture device 8 to capture at least some of the content 5, 6, 7 provided by the content provider 1. For example, the content provider 1 may manage a location 1a, for example a visitor attraction such as a zoo, to which access may be limited and where a consumer 2 may wish to capture content, for later viewing and/or printing, in circumstances where the consumer 2 is visiting the location 1a. The content may, for example, be in the form of digital photographs of co-visitors at the attraction including distinctive features of the attraction, or of preprepared digitally stored information about the location or subject matter, such as animal habitats, connected with the location. Alternatively, the content provider 1 may manage an event such as a trade show or an object such as a mobile attraction, and in circumstances where a consumer 2 is visiting the object or event, the consumer 2 may wish to capture information about the event in the form, for example, of brochures, of business cards or of snapshots of products.

The provider 3 of printing consumables is, for example, a manufacturer and/or seller of at least one type of printing consumable, for example ink cartridges for ink jet printers, toner cartridges for laser printers, ink or toner for refilling such cartridges, paper or other sheet-like printable media or any other product or substance which is depleted during printing activity.

The discounted consumer printing service provider 4 provides a discounted consumer printing service for enabling the other parties 1, 2, 3 to implement various aspects of a discounted printing process described in further detail below. The discounted consumer printing service provider 4 is shown as a separate entity, but the functions of the discounted consumer printing service provider 4 may alternatively be carried out by the printing consumables provider 3.

The consumer 2 possesses printing apparatus 9 connectable for communication with the capture device 8 or a storage device, such as a memory card, which is removable from the capture device 8 with captured content stored thereon. The printing apparatus shown in FIG. 1 comprises computer apparatus in the form of a personal computer (PC) 10, display means in the form of a monitor having a display screen 11, a printer device 12, and command input apparatus in the form of a keyboard 13 and mouse 14, for inputting user commands to the PC 10. The PC 10 is connectable to a communications network such as the internet 17 for communication with the other parties 1, 3, 4.

Many alternative forms of printing apparatus will be apparent to the skilled reader. For example, the printing apparatus may alternatively comprise a printer device having computer processing capability and hardware, firmware and/or software adapted to provide printing capability from the capture device 8 directly, or indirectly via remote storage. Alternatively, the capture device 8 may be capable of printing images directly thereon.

The printing consumables provider 3 takes orders from the consumer 2 when required, for supplying at least one type of printing consumable 20. The printing consumables provider 3 is shown as being equipped for electronic commerce (e-commerce), having for this purpose a computerised ordering system including computing apparatus 21 for communicating with consumers 2 over a communication network 17 such as the internet. However, it will be apparent to the skilled reader that the printing consumables provider 3 may alternatively or additionally use another method of commerce for providing the printing consumables.

The discounted consumer printing service provider 4 manages a system for authorising discounted consumer printing, the system including computer apparatus 22 arranged to communicate with the other parties over a communication network, for example the internet 17. The computer apparatus 22 can take any convenient form, and may comprise separate and/or geographically distributed interconnected devices.

The content provider 1 arranges for identifying data 30 to be made available for capture by the consumer 2 and/or his capture device 8 under specific circumstances in which the content provider 1 wishes to encourage the consumer 2 to print out at least some of the content 5, 6, 7. For example, the content provider may define the specific circumstances to include that the consumer must have gained entry to and/or be present at a time of capture at a location or event, and authorise that discounted printing will apply to content so captured. In this case, the identifying data 30 may be, for example: data captured with a visual image identifying the location; an entry ticket to the event; a digital certificate issued to the consumer 2 on entry to the location; or digital data captured by a capture device 8 at the location from a local IR or RF beacon 31 or swipe device. The digital data may be captured together with the any preprepared digital information 6. The identifying data 30 may include, for example, the time and location of capture, the type of content captured and any time limitation on discounted printing authorisation. The identifying data may alternatively comprise any other form of data suitable for evidencing to the discounted consumer printing service provider 4 that content 5, 6, 7 was captured on the capture device 8 by the consumer 2 in authorised defined circumstances.

Thus, the content provider 1 authorises defined sets of circumstances in which it is willing to allow a consumer 2 to capture content which can later be printed by the consumer 2 at a discount to the consumer 2 on his printing costs. The presently authorised capture circumstances in which discounted printing will be authorised are communicated by the content provider to the discounted printing service provider 4 over the communications network 17 or in any other appropriate way.

The computer apparatus 22 of the discounted consumer printing service provider 4 comprises recognition apparatus in so far as it is programmed to recognise the identifying data 30 relating to the content 5, 6, 7 captured in the authorised defined circumstances, for facilitating discounted printing by the consumer 2. To this end, the computer apparatus 22 includes memory containing regularly updated identification data 22a relating to defined sets of circumstances which are presently authorised by the content provider 1 for discounted printing.

The authorised defined circumstances will generally relate to a location or event at which capture is effected, and may include a time of capture. However, any convenient set of circumstances may be authorised provided it is possible to establish evidence of capture in such circumstances.

The content provider 1, by prior agreement with the discounted consumer printing service provider 4, is able to associate content captured in the authorised circumstances, such as at specified locations or events, with a discount for consumer printing of the captured content or further content linked thereto. The discount offered is a proportion of the estimated cost to the consumer 2 of consumer printing of the captured content or the linked content, and may be the full estimated cost.

“Consumer printing” in this context includes printing using personal printing apparatus, for example the printing apparatus 9, whereby the consumer 2 is directly responsible for costs associated with the printing process, as contrasted with printing by a commercial printing service using its own commercial printing apparatus. However, consumer printing should be understood also to include printing on business premises for use of the printed output by the consumer for the purposes of that business.

In return for using the consumer printing service, the content provider 1 agrees to recompense the discount printing service provider 4. The service provider 4 benefits further because the discount is only realisable through the particular printing consumables provider 3 associated with the service provider 4. Where the consumables provider 3 and discount printing service provider 4 are the same entity or affiliated entities, the value of the printing discount given to the consumer 2 may be at least partially compensated for by increased demand for printing consumables.

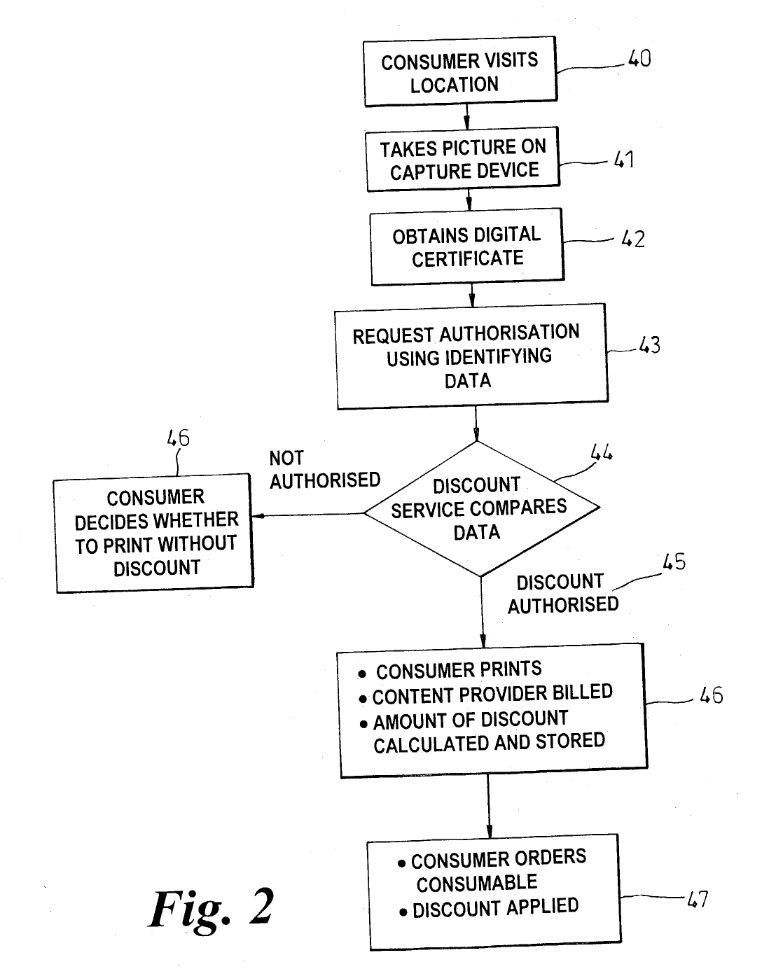

FIG. 2 is a flow diagram illustrating a method wherein a consumer 2 visits the location 1a (step 40) with the capture device 8 in the form of a wireless PDA including a digital camera. Around the point of entry to the location 1a, or by other means, the content provider 1 informs the consumer 2 that for a specified time period following his visit he will be allowed to print on his home printing apparatus 9 content in the form of photographic images 5 and specified digital information 6 pertaining to the location which have been captured during his visit. In this manner, the content provider 1 as location manager intends to stimulate interest and goodwill in the location and subject matter associated with the location, in that visitors will be encouraged to print out images of their visit which would otherwise remain in digital form, and will print out and read information relating to associated issues pertaining to the activities of the location, which information may include marketing material.

The consumer 2, encouraged by the offer of discounted printing, during his visit captures content in the form of digital photographs (step 41). The consumer 2 also obtains further identifying data 30 in the form of a digital certificate identifying the date and location visited (step 42). Where the location is an attraction, such as a zoo or leisure park, the digital certificate may be given away free of charge on entry to the location 1a, or alternatively may be sold, given away, or its discount value enhanced in return for the consumer 2 partaking in revenue generating activities such as certain purchases of goods or services at the location 1a. Alternatively, where the location is an event, such as a trade show, the digital certificate may be provided by a trade show organiser or participant to certain categories of visitor for discounted printing of images of products, brochures, business cards and similar materials which may be casually captured at the event.

When the consumer 2 returns home, he considers whether to print any of the captured content 5. In order to realise the discount for printing, the consumer 2 may be required to print the content 5 within a predetermined time period following capture or another specified event. Influenced by the discount offered, the consumer 2 decides to print all the digital photographs 5 immediately. He ensures the digital certificate 30 is loaded on the capture device 8 and connects the capture device 8 to the printer device 12, directly or via the PC 10. The consumer 2 then requests from the discounted consumer printing service 4 authorisation for discounted printing (step 43).

To obtain authorisation for discounted printing, the printing apparatus 9 communicates via the network 17 with the computer apparatus 22, which decides (step 44) whether the identifying data 30 corresponds to the identification data 22a stored on the computer apparatus 22, prior to authorising discounted printing. The computer apparatus 22 also establishes whether a predetermined permitted time period has elapsed within which a discount is permitted. Furthermore, before authorising a discount the computer apparatus 22 accesses from the printing apparatus 9 information relating, for example, to the type of printer device 12 and its printer cartridge type.

Clearly, for efficient operation of the discount printing service the identifying data 30 in the form of the digital certificate should be securely associated with the content which is to be printed at a discount, so that users of the system can be confident that identifying data originating from unauthorised sources cannot be impermissibly recognised as genuine identifying data. In the presently described first embodiment, one way of facilitating such security of association is to ensure that the capture device 8 on which the content 5, 6, 7 has been captured and stored is connected for interrogation thereof by the computer apparatus 22 prior to authorisation of a discount and also that the digital certificate is resistant to tampering and thus cannot easily be altered or replicated. Many appropriate methods for securing the identifying data will be apparent to the skilled reader.

In a modification of the first embodiment, the identifying data 30 could be provided by an entry ticket and/or information detectable in the photographic image, for example a recognisable physical feature of the location 1a or digitally recognisable information such as a sign visible in the image.

To make use of the discounted printing service, the consumer 2 and/or the printer device 12 is registered with the discount service provider 4. Consumer registration can be effected at any convenient time. For example, the consumer 2 may register for the service immediately prior to the first authorised printing event. Consequently, the discounted printing service provider 4 opens an account 26 in respect of the consumer 2 and/or printer device 12.

The account 26 may be stored on the computer apparatus 22 and/or the printing apparatus 9, or may be part stored on each of the computer apparatus 22 and the printing apparatus 9. The account 26 comprises, for example a computer program implemented in firmware, software and/or hardware.

A processing module 9a is provided for collecting and processing data for, and communicating with, the account 26. For example, the module 9a receives from the computer apparatus 22 cost, account status and authorisation data, gathers from the printing apparatus 9 identifying data 30 and print event data, including printer consumption and the serial numbers of printer devices and printer cartridges, and receives from the computing apparatus 21 data relating to discounts provided. The module 9a is conveniently part of the printing apparatus 9, and in the fist embodiment is provided in the printer device 12. Alternatively, the module could be stand alone or provided in the PC 10. The module 9a may be implemented in firmware, software and/or hardware.

The service provider 4 authorises discounted printing only if module 9a at the time of printing sends to the computer apparatus 22 a signal confirming use of a printer and/or printer cartridge of predetermined type. This encourages use of equipment authorised by the service provider 4, which may for example be restricted to equipment provided by the printing consumables provider 3.

When discounted printing is authorised, the computer apparatus 22 sends a signal for receipt by the printing apparatus 9 authorising discounted printing (step 45). If communication with the computer apparatus 22 is not maintained during printing, the printing apparatus can store details of the printing in the module 9a, for automatically updating the account 26 with the discounted amount when communication is re-established. In the present embodiment, the signal is passed to the module 9a which causes the printer device 12 to print the content automatically. Alternatively, the module 9a presents information to the consumer 2 regarding the discount authorised and the cost of printing, and requires input of a further user command before printing commences. If no discount is authorised, the consumer is informed and given the opportunity to proceed with printing without any discount being applied (step 46).

Following printing (step 46), the printing outcome is reported by the printing apparatus 9 to the service provider 4. The report confirms the content actually printed and furthermore contains data collected by the module 9a for use in estimating the actual costs of the printing event to the consumer 2. The collected data includes, for example, the amount and type of ink and the quantity and type of printable media, such as paper and overhead transparencies, used in the printing, and usage details of any other printing consumable as required. The collected data further includes at least one of: the type of printer and print cartridge used and a unique identifier for the printer 12. The account module 9a is used to automatically store data relevant to authorisation and estimation purposes, and to communicate this data to the computer apparatus 22 when communication is established. Account data can be held in the module 9a for presenting account information to the consumer 2 offline.

The data from the report is received, processed and stored in the account 26 by the computer apparatus 22. Alternatively, the data is at least partially processed by the module 9a and/or the PC 10 before sending to the computer apparatus 22. The processing results in an estimation of the actual costs incurred by the consumer 2 for locally printing the discounted content. The precise method of calculation can be varied as desired. Printer amortisation costs are optionally included ie the printer 12 is treated as a consumable for the purposes of the estimation. Estimated costs of printing events are stored in the account 26. Following printing 39, the consumer 2 may be automatically informed of the estimated printing costs and the discounted amount, and also of the cumulative total discount stored against his account and not redeemed.

Following the printing event, a stakeholder in the content, for example the content provider 1, is billed in an automated fashion for the discount. Alternatively, where the discounted printing service provider 4 and printing consumables provider 3 are integral or affiliates, no further charge may be necessary. In this connection, by virtue of the discounted printing service, additional demand may be generated for printing consumables to be supplied by the printing consumables provider 3. The stakeholder may be any person or entity having an interest in whether the consumer 2 views and prints captured content, and may be a further party who asks the content provider 1 to make content available on its behalf.

Billing the content provider 1 automatically and immediately after printing is not essential, and many other ways and times of settling the charge from the service provider 4 to the content provider 1 will be apparent to the skilled reader. For example, the content provider 1 may be billed only after a consumer 2 is provided with discounted printing consumables.

When the consumer orders the replacement ink cartridge or other printing consumable from the consumables provider 3 (step 47), the computing apparatus 21 of the consumables provider 3 interrogates the computer apparatus 22 of the discount printing service 4 to determine a total discount value presently credited to an account associated with the consumer 2 and/or the printing apparatus 9 of the consumer 2. The printing consumables provider 3 is then able to confirm the order and the discount.

The consumer 2 will have an incentive to direct his purchase request to the particular printing consumables provider 3 who is offering a discount via the discounted printing service 4, thus providing additional business to the consumables provider 3 and differentiating the consumables provider's services from those of its competitors. In one aspect of the embodiment, such requests are only possible over e-commerce channels, although in other aspects other sales and distribution channels may also be provided.

It is advantageous that the printing consumables provider 3 itself provides and manages the discount printing service, thereby obviating the requirement to deal with the third party service provider 4.

Because discounts are realisable in proportion to the costs incurred and only against printing consumables, spurious printing of content which may otherwise be of little interest to the consumer, merely to obtain some sort of credit or reward, is discouraged.

Alternative methods of effecting authorisation of discounted printing and of realising the discount will be apparent to the skilled man. Some further examples are described in copending UK Patent Application Number 0125124.8 filed on 19 Oct. 2001.

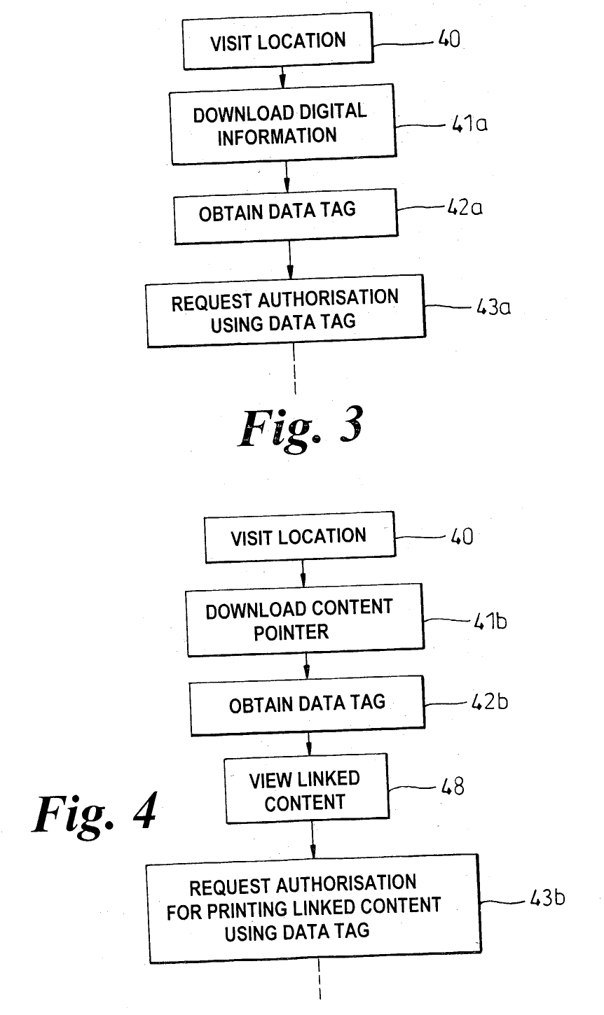

A modified process relating to a second embodiment will now be described with reference to FIG. 3. This modified process is similar to the above-described process of the first embodiment except as described below, in connection with the type of content that is offered for discount printing. Therefore, to avoid redundant description, only aspects which differ from the first embodiment will be described in detail, and similar reference signs will be used for items which have a similar function as in the first embodiment.

The content provider 1 provides electronic information points at the location from which the consumer 2 can download preprepared digital information 6 onto the capture device 8 (step 41a). The download connection can be effected, for example by direct connection of the capture device 8 with a terminal of the information point, by infra-red communication or by radio-frequency transmission. The information point is adapted to download identifying data 30 in the form of a data tag (step 42a) with the digital information 6, either as an integral part of that information or separately therefrom, for storage on the capture device 8. Alternatively, the digital information 6 and identifying data could be provided on a memory storage device such as a memory card insertable into the capture device, whereby is not necessary to download the information directly onto the capture device's integral memory. The identifying data need not be transmitted at the same time as the digital information, and can be stored onto the capture device or storage device at any convenient point, preferably during the visit.

When the consumer 2 wishes to print the captured information 6, he communicates with the discounted consumer printing service 4 to request authorisation for discounted consumer printing, whereby the data tag serves as identifying data 30 (step 43a).

A further modified process relating to a third embodiment will now be described with reference to FIG. 4. This modified process is similar to the above-described process of the second embodiment except as described below, in connection with the type of content that is captured. Therefore, to avoid redundant description, only aspects which differ from the second embodiment will be described in detail, and similar reference signs will be used for items which have a similar function as in the first and second embodiments.

The content provider 1 provides content in the form of pointer information 7, hereinafter referred to as a pointer, such as a uniform resource locator (URL). The pointer provides the consumer with a link to preprepared digital information 7a obtainable elsewhere, for example on the world wide web, using the consumer's PC 10. The pointer 7 can be captured in any convenient manner (step 41b), for example from electronic information points or storage devices at the location in a similar manner to the information 6 in the second embodiment, or by local RF broadcast from a beacon 31. Information accompanying the pointer 7 may indicate the nature of and printing discount available for the pointed-to information 7a. Identifying data 30 in the form of a secure data tag is also obtained together with or separately from the pointer 7 (step 42b), similarly to the data tag in the second embodiment.

Following the visit, the consumer uses the URL to locate the pointed-to information 7a and views the information 7a (step 48). If the consumer 2 wishes to print this linked information 7a, he communicates with the discounted consumer printing service 4 to request authorisation for discounted consumer printing, whereby the data tag serves as identifying data 30 (step 43b) as for previous embodiments.

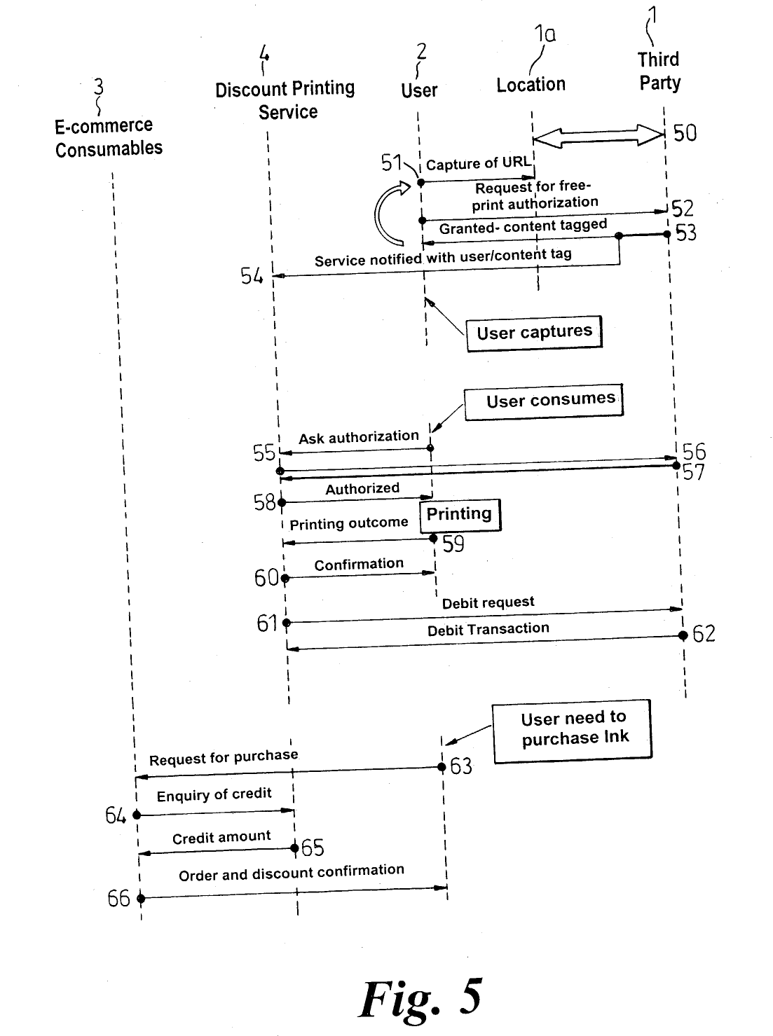

FIG. 5 shows a detailed modification of the third embodiment. Step 50 indicates provision of pointer information in the form of a URL 7 at the location 1a by the content provider 1 or other third party stakeholder in the pointed-to content 7a. The consumer 2 captures the URL 7 at the location 1a (step 51). The location could be a sales location, for example a vehicle showroom, where potential customers can capture the URL of an object, for example a car, and later download customised and personalised information from the world wide web for free. However, many other suitable types of location will be apparent to the skilled reader.

The consumer 2 uses the capture device 8 to request authorisation for discounted printing of the pointed-to content 7a (step 52) from a computer system managed by the content provider 1. The content provider 1 ensures that identifying data in the form of a data tag is transmitted to the capture device 8 of the consumer 2 (step 53). The data tag is associated with the authorised content 7a. Authorisation details in respect of the tag 30, the tagged information 7a and the consumer 2 are sent by the content provider 1 to the discounted consumer printing service provider 4 (step 54).

After the visit, the consumer 2 requests authorisation for discount printing from the discount printing service 4 (step 55). The discount printing service 4 may request and receive confirmation from the content provider 1 that authorisation still applies (steps 56 and 57), although these steps may not be necessary in cases where the preauthorisation by the content provider 1 tagging the information 7a is sufficient. The discount printing service 4 exchanges data with the module 9a to carry out an estimate of printing costs and verify that an authorised type of printing device 12 and cartridge 20 are being used for printing, and authorises the discount (step 58).

The module 9a reports the printing outcome to the discount printing service 4 (step 59) and the discount printing service 4 confirms the discount to the consumer 2 (step 60). The content provider's account is debited and the transaction settled automatically and electronically (steps 61 and 62 respectively).

When the consumer 2 makes a purchase order electronically to the consumables provider 3 (step 63), in this case an e-commerce service, the consumables provider 3 enquires of the discount printing service 4 the amount of discount credited to the consumer's account (step 64). The discount printing service 4 provides the necessary information (step 65), enabling the consumables provider 3 to confirm the order and the amount of discount to the consumer 2 (step 66). The information can be passed quickly and automatically between the parties 1, 2, 3, 4 using computerised systems without undue delay to the consumer 2 in receiving confirmation of his order and the discount applicable.

In a modification of the above embodiments, the capture device 8 includes location-aware apparatus, for example global positioning system (GPS) apparatus or another location-based information apparatus, for indicating in real time whether the capture device 8 is presently being used in a location where discounted printing of content is allowed. Location criteria may be used in combination with other circumstantial criteria to decide whether particular content is presently authorised.

Features described above with respect to only one of the embodiments can be used with other embodiments, and the specification should be understood to specifically include such combinations.

At least some of the above-described embodiments provide a convenient method of passing to a consumer a discount for consumer printing of content captured in specific locations, events or situations where a stakeholder in content is willing to subsidise its printing. One way of facilitating the method is to securely tag captured content with time and/or spatial context information gathered during the capture process.

Using at least one of the embodiments in a location-based services context, a pointer to content, or the primary content itself, can be captured by a location-aware camera or PDA and, if the time and/or location is authorised, the pointer or primary content is tagged as authorised for subsidised printing.

The embodiments described above facilitate discounted, including effectively free, printing by a consumer at a time and location which is convenient to him. The consumer sees a direct correlation between a discount and an amount of discounted content printed on an authorised printer. A content provider 1 can distinguish itself from or compete more effectively with competitors by offering content in association with discounted printing.

1. A method for authorising discounted printing, comprising identifying content which has been captured by a consumer in authorised defined circumstances, and authorising discounted consumer printing of the identified content or of further content linked to the identified content.

2. A method as claimed in claim 1, wherein identifying data relating to the circumstances of capture is used for securely identifying whether content has been captured in authorised defined circumstances.

3. A method as claimed in claim 2, wherein the identifying data comprises a digital certificate storable in a capture device for association with content captured by the device.

4. A method as claimed in claim 2, wherein the identifying data has been captured and stored with the captured content.

5. A method as claimed in claim 2, wherein the identifying data has been captured at or around a time of capture of the captured content.

6. A method as claimed in claim 2, wherein the identifying data comprises a visual, infra-red (IR) or radio-frequency (RF) tag.

7. A method as claimed in claim 1, wherein a consumer is informed in real time of whether content capturable at a present time and/or location of the consumer is presently authorised for discounted printing.

8. A method as claimed in claim 7, comprising using a capture device including location-aware apparatus.

9. A method as claimed in claim 1, wherein the defined circumstances relate to a location, object and/or time of capture.

10. A method as claimed in claim 1, wherein the captured content is an image or preprepared digital information.

11. A method as claimed in claim 1, wherein discounted consumer printing is authorised only if a capture device used to capture the identified content is connected for interrogation thereof at a time of printing, and has the identified content stored thereon.

12. A method as claimed in claim 1, wherein discounted consumer printing is authorised only when printing is effected directly from a capture device used to capture the identified content.

13. A method as claimed in claim 1, wherein discounted consumer printing is authorised only within a defined period of time following content capture or issue of the identifying data.

14. A method as claimed in claim 1, comprising estimating costs incurred by a consumer for printing the identified or linked content.

15. A method as claimed in claim 1,,comprising providing printing consumables to the consumer at a discount substantially proportional to estimated printing costs.

16. A method as claimed in claim 1, comprising billing a stakeholder in the identified or linked content for provision of discounted consumer printing services including authorisation of discounted printing and/or providing consumables to the consumer at a discount.

17. Computer apparatus having stored thereon data relating to authorised defined capture circumstances, for use in a method as claimed in claim 1, the computer apparatus being operable to automatically compare identifying data relating to captured content with stored data relating to authorised defined capture circumstances and to authorise or deny discounted consumer printing according to results of the comparison.

18. A system for authorising discounted printing, the system being operable to identify content which has been captured by a consumer in authorised defined circumstances, and to authorise discounted consumer printing of the identified captured content or of further content linked to the identified captured content.

19. A system as claimed in claim 18, comprising estimating apparatus operable to estimate costs incurred by a consumer for printing the identified or linked content.

20. A system as claimed in claim 19, operable to store the estimated costs automatically and electronically in an account associated with a consumer and/or at least one printing apparatus of the consumer.

21. A system as claimed in claim 18, operable to provide information to a printing consumables provider regarding a total discount value presently credited to an account associated with the consumer and/or a printing apparatus of the consumer.

22. A system as claimed in claim 18, operable to bill a stakeholder in the content, so as to pass on to the stakeholder at least some costs associated with the discounted printing.

23. A method for use in authorising discounted consumer printing, comprising providing, for receipt by a consumer and/or a capture device of the consumer, identifying data for association with content captured in defined circumstances so as to enable secure identification of the circumstances in which the content was captured.

24. A method as claimed in claim 23, wherein the defined circumstances comprise a location or object visited by the consumer, and the identifying data, containing circumstantial details of the visit, is in the form of at least one selected from the following: a human-readable hard copy retainable by the consumer; a digital certificate storable on a hand held capture device; and an IR or RF tag capturable by a hand held capture device.

25. A method as claimed in claim 23, wherein the captured content is at least one selected from the following: a digital picture taken using an image capture device of the consumer; and digital information captured electronically from an information store.

26. A method as claimed in claim 23, wherein the identifying data is integrated into the captured content, whereby the circumstances in which content has been captured are, at least in part, identifiable from the captured content.

27. A capture device, for use with a method as claimed in claim 23, operable to receive identifying data in defined circumstances and to associate the identifying data with content captured in the defined circumstances so as to enable secure identification of the captured content and of the circumstances in which it was captured.

28. A method of providing discounted printing consumables to a consumer thereof, the discount representing a proportion of the costs incurred by the consumer for consumer printing of captured content, or of further content linked to said captured content, wherein a condition of the discounting is that said captured content is captured in defined circumstances.

29. A method of associating content, which has been captured in defined circumstances, with a discount service so as to enable discounted consumer printing of the captured content or of further content linked to the captured content.

30. A method wherein a discounted consumer printing service provider provides a discount printing service for consumers of content captured in authorised defined circumstances, or of content linked to the captured content, the service including the provision of information enabling a printing consumables provider to provide to respective said consumers printing consumables at a discount related to an estimated cost of printing said content by the respective consumers, for thereby encouraging the consumers to print said content.

31. A method wherein a printing consumables provider provides for a stakeholder in content captured by a consumer in authorised defined circumstances, or of content linked to the captured content, a discount printing service wherein the printing consumables provider provides printing consumables to the consumer at a discount related to estimated costs of printing by the consumer of said content, whereby the consumer is encouraged to print said content.

32. A method of identifying content which has been captured by a consumer in authorised defined circumstances, for authorising discounted consumer printing of the identified content or of further content linked to the identified content, wherein identifying data relating to the circumstances of capture, which has been captured and stored with the captured content, is used for securely identifying whether the captured content has been captured in said authorised defined circumstances.

33. A method of identifying content which has been captured by a consumer in authorised defined circumstances, for authorising discounted consumer printing of the identified content or of further content linked to the identified content, comprising;
a) using identifying data relating to the circumstances of capture for securely identifying whether the captured content has been captured in said authorised defined circumstances;
b) estimating costs incurred by a consumer for printing the identified or linked content;
c) providing printing consumables to the consumer at a discount substantially proportional to estimated printing costs; and
d) billing a stakeholder in the identified or linked content for provision of discounted consumer printing services including authorisation of discounted printing and/or providing consumables to the consumer at a discount.

34. A method as claimed in claim 33, wherein the authorised defined circumstances include a location of capture, and the identifying data comprises a ticket issued in a vicinity of said location, a digital tag captured by a capture device of the consumer from an IR or RF source in a vicinity of said location, or a digital certificate issued in a vicinity of said location.

35. Means for authorising discounted printing, comprising means for identifying content which has been captured by a consumer in authorised defined circumstances, and means for authorising discounted consumer printing of the identified content or of further content linked to the identified content.

36. Means for authorising discounted printing as claimed in claim 35, further comprising means for securely identifying whether content has been captured in authorised defined circumstances.
